(19) United States
(12) Patent Application Publication
(10) Pub. No.: US 2023/0374335 A1
(43) Pub. Date: Nov. 23, 2023

(54) ODOR CONTROL POLYMER COATINGS ON TEXTILES

(71) Applicant: MiCROBAN PRODUCTS COMPANY, Huntersville, NC (US)

(72) Inventors: Li YIHONG, Huntersville, NC (US); Ivan Wei Kang ONG, Charlotte, NC (US); Xiuzhu FEI, Charlotte, NC (US)

(21) Appl. No.: 18/200,195

(22) Filed: May 22, 2023

Related U.S. Application Data
(60) Provisional application No. 63/344,191, filed on May 20, 2022.

(51) Int. Cl. C09D 133/08; C09D 175/04

(52) U.S. Cl. CPC C09D 133/08; C09D 175/04

(57) ABSTRACT

A composition and method for treating a textile to impart a property of prolonged odor control to the textile is provided. The method includes applying a composition having sodium pyrithione and a binder to a textile, thereby imparting odor control to the textile. The composition may further contain a softener.

### CROSS REFERENCE TO RELATED APPLICATIONS

This application claims priority from U.S. Provisional Patent Application No. 63/344,191, filed on May 20, 2022, in the United States Patent and Trademark Office. The disclosure of which is incorporated herein by reference in its entirety.

### FIELD OF THE INVENTION

The present invention relates to a composition and method for treatment of a textile, more particularly to a composition and method for imparting odor control and improving color fastness to a textile.

### BACKGROUND OF THE INVENTION

Current major odor control technologies on textiles are through adsorption of odorants by common adsorbents, such as activated carbon, zeolites, and some heavy metal containing actives. Heavy metal products are a cause for environmental and regulatory concern to not only regulators but also consumers. Effluent discharged from manufacturing facilities endanger aquatic lives and cause long term toxicity. Additionally, metal containing actives as well as activated carbon and zeolites are generally insoluble particles that tend to aggregate and build up on machinery causing manufacturing issues. After application to textiles, the particles result in poor tactile sensation on the substrates; this is due to the existence of fine particle on the surface, leading to increased abrasion. Similarly, the color fastness is often reduced to some extent, when these heavy metal containing compositions are used.

The present invention provides a solution for imparting odor control properties and wash durability to a textile as well as improving colorfastness of a textile, while meeting evolving requirements of heavy metal-free formulations.

### SUMMARY OF THE INVENTION

The present invention is a composition comprising sodium pyrithione and a binder for providing an odor control property and wash durability to a textile.

This invention provides a solution for odor control through adsorption on a textile while meeting evolving requirements of heavy metal-free formulations and eliminating the use of fine particles to impart good hand and good color fastness to the textiles.

In an aspect of the invention, an odor control composition is provided comprising an effective amount of sodium pyrithione to reduce odor on a textile and an effective amount of binder to coat the textile.

In some aspects, the odor control composition comprises from 6 weight percent to 15 weight percent sodium pyrithione. In some aspects, the odor control composition comprises from 8 weight percent to 13 weight percent sodium pyrithione. In some aspects, the odor control composition comprises between 10 weight percent and 12 weight percent sodium pyrithione.

In some aspects, the odor control composition comprises from 40 weight percent to 55 weight percent of the binder. In some aspects, the odor control composition comprises between 43 weight percent and 50 weight percent of the binder. In some aspects, the odor control composition comprises between 45 weight percent and 48 weight percent of the binder. In some aspects, the binder is a polyacrylic binder. In some aspects, the binder is a polyurethane binder. In some aspects, the binder is a combination of a polyacrylic binder and a polyurethane binder.

In some aspects, the composition is heavy metal-free.

In some aspects, the composition further comprises from 15 weight percent to 20 weight percent of a softener. In some aspects, the odor control composition comprises from 16 weight percent of the softener. In some aspects, the odor control composition comprises from 17 weight percent to 18 weight percent of the softener. In some aspects, the softener is selected from the group consisting of a sulphated fatty alcohol, anionic fatty acid polysiloxane, nonionic fatty acid polysiloxane, ethoxylated polysiloxane, polyethylene based softener, and a combination thereof.

In some aspects, water is the balance of the total weight of the composition.

In some aspects, the odor control composition, when applied to a textile, reduces odors up to twenty-five home launderings.

In an aspect of the invention, an odor control composition is provided comprising an effective amount of sodium pyrithione to reduce odor on a textile, an effective amount of binder to coat the textile, and from 15 weight percent to 20 weight percent of a softener.

In some aspects, the odor control composition comprises from 6 weight percent to 15 weight percent sodium pyrithione. In some aspects, the odor control composition comprises from 8 weight percent to 13 weight percent sodium pyrithione. In some aspects, the odor control composition comprises between 10 weight percent and 12 weight percent sodium pyrithione.

In some aspects, the odor control composition comprises from 40 weight percent to 55 weight percent of the binder. In some aspects, the odor control composition comprises between 43 weight percent and 50 weight percent of the binder. In some aspects, the odor control composition comprises between 45 weight percent and 48 weight percent of the binder. In some aspects, the binder is a polyacrylic binder. In some aspects, the binder is a polyurethane hinder. In some aspects, the binder is a combination of a polyacrylic hinder and a polyurethane binder.

In some aspects, the odor control composition comprises from 16 weight percent of the softener. In some aspects, the odor control composition comprises from 17 weight percent to 18 weight percent of the softener. In some aspects, the softener is selected from the group consisting of a sulphated fatty alcohol, anionic fatty acid polysiloxane, nonionic fatty acid polysiloxane, ethoxylated polysiloxane, polyethylene based softener, and a combination thereof.

In some aspects, the composition is heavy metal-free.

In some aspects, water is the balance of the total weight of the composition.

In some aspects, the odor control composition, when applied to a textile, reduces odors up to twenty-five home launderings.

In an aspect of the invention, an odor control composition is provided comprising an effective amount of sodium pyrithione to control odor, from 25 weight percent to 35 weight percent of a polyacrylic binder, and from 15 weight percent to 20 weight percent of a polyurethane binder.

In some aspects, the odor control composition comprises from 6 weight percent to 15 weight percent sodium pyrithione. In some aspects, the odor control composition comprises from 8 weight percent to 13 weight percent sodium pyrithione. In some aspects, the odor control composition comprises between 10 weight percent and 12 weight percent sodium pyrithione.

In some aspects, the odor control composition comprises from 27 weight percent to 33 weight percent of the polyacrylic binder. In some aspects, the odor control composition comprises from 29 weight percent to 31 weight percent of the polyacrylic binder.

In some aspects, the odor control composition comprises from 16 weight percent to 19 weight percent of the polyurethane binder. In some aspects, the odor control composition comprises from 17 weight percent to 18 weight percent of the polyurethane binder.

In some aspects, the composition is heavy metal-free.

In some aspects, the composition further comprises from 15 weight percent to 20 weight percent of a softener. In some aspects, the odor control composition comprises from 16 weight percent to 19 weight percent of the softener. In some aspects, the odor control composition comprises from 1.7 weight percent to 18 weight percent of the softener.

In seine aspects, the softener is selected from the group consisting of a sulphated fatty alcohol, anionic fatty acid polysiloxane, nonionic fatty acid polysiloxane, ethoxylated polysiloxane, polyethylene based softener, and a combination thereof. In some aspects, the odor control composition comprises from 16 weight percent of the softener. In some aspects, the odor control composition comprises from 17 weight percent to 18 weight percent of the softener.

In some aspects, water is the balance of the total weight of the composition.

In some aspects, the odor control composition, when applied to a textile, reduces odors up to twenty-five home launderings.

In an aspect of the invention, a method of treating a textile is provided. The method comprises applying a composition to a textile to impart an odor control property and wash durability, wherein the composition comprises sodium pyrithione at an effective amount to reduce odor on the textile, and a binder at an effective amount to coat the textile.

In some aspects, the odor control composition comprises from 6 weight percent to 15 weight percent sodium pyrithione. In some aspects, the odor control composition comprises from 8 weight percent to 13 weight percent sodium pyrithione. In some aspects, the odor control composition comprises between 10 weight percent and 12 weight percent sodium pyrithione.

In some aspects, the odor control composition comprises from 40 weight percent to 55 weight percent of the binder. In some aspects, the odor control composition comprises between 43 weight percent and 50 weight percent of the binder. In some aspects, the odor control composition comprises between 45 weight percent and 48 weight percent of the binder. In some aspects, the binder is a polyacrylic binder. In some aspects, the binder is a polyurethane binder. In some aspects, the binder is a combination of a polyacrylic binder and a polyurethane binder.

In some aspects, the composition is heavy metal free.

In some aspects, the composition further comprises from 15 weight percent to 20-weight percent of a softener. In some aspects, the odor control composition comprises from 16 weight percent to 19 weight percent of the softener. In some aspects, the odor control composition comprises from 17 weight percent to 18 weight percent of the softener. In some aspects, the softener is selected from the group consisting of a sulphated fatty alcohol, anionic fatty acid polysiloxane, nonionic fatty acid polysiloxane, ethoxylated polysiloxane, polyethylene based softener, and a combination thereof.

In some aspects, water is the balance of the composition.

In some aspects, the textile is a fabric.

In some aspects, the composition is applied by a method selected from the group consisting of padding, spraying, roller coating, exhaustion, and a combination thereof.

In some aspects, the composition is applied to the textile by padding in a padding bath. In some aspects, after padding, the textile is cured at a curing temperature from 130° C. to 180° C. In some aspects, after padding, the composition is cured onto the textile for a minimum of 45 seconds.

In some aspects, the composition is applied to the textile by exhaustion. In some aspects, the composition is added during the dyeing stage of exhaustion. In some aspects, the composition is exhausted for a time period from twenty minutes to one hour.

In some aspects, the composition is added at a temperature from 60° C. to 130° C.

In some aspects, the color on the textile remains visually unchanged after applying the composition.

In some aspects, the method results in a textile having reduced odors up to twenty-five home launderings.

In an aspect of the invention, an article is provided; the article comprising a textile material treated with a composition comprising sodium pyrithione at an effective amount to reduce odor on the textile and a binder at an effective amount to coat the textile.

In some aspects, the odor control composition comprises from 6 weight percent to 15 weight percent sodium pyrithione. In some aspects, the odor control composition comprises from 8 weight percent to 13 weight percent sodium pyrithione. In some aspects, the odor control composition comprises between 10 weight percent and 12 weight percent sodium pyrithione.

In some aspects, the odor control composition comprises from 40 weight percent to 55 weight percent of the binder. In some aspects, the odor control composition comprises between 43 weight percent and 50 weight percent of the binder. In some aspects, the odor control composition comprises between 45 weight percent and 48 weight percent of the binder. In some aspects, the binder is a polyacrylic binder. In some aspects, the binder is a polyurethane binder. In some aspects, the binder is a combination of a polyacrylic binder and a polyurethane binder.

In some aspects, the composition further comprises from 15 weight percent to 20 weight percent of a softener. In some aspects, the odor control composition comprises from 16 weight percent to 19 weight percent of the softener. In some aspects, the odor control composition comprises from 17 weight percent to 18 weight percent of the softener. In some aspects, the softener is selected from the group consisting of a sulphated fatty alcohol, anionic fatty acid polysiloxane, nonionic fatty acid polysiloxane, ethoxylated polysiloxane, polyethylene based softener, and a combination thereof. In some aspects, the odor control composition comprises from 16 weight percent of the softener. In some aspects, the odor control composition comprises from 17 weight percent to 18 weight percent of the softener.

In some aspects, the composition is heavy metal free.

In some aspects, water is the balance of the total weight of the composition.

In some aspects, the composition further imparts improved colorfastness to the textile. In some aspects, the article maintains the ability to reduce odors up to twenty-five home launderings.

Further areas of applicability of the present invention will become apparent from the detailed description provided hereinafter. It should be understood that the detailed description and specific examples, while indicating the preferred embodiments of the invention, are intended for purposes of illustration only and are not intended to limit the scope of the invention.

### DESCRIPTION OF THE PREFERRED EMBODIMENTS

The following description of the embodiments of the present invention is merely exemplary in nature and is in no way intended to limit the invention, its application, or uses. The following description is provided herein solely by way of example for purposes of providing an enabling disclosure of the invention, but does not limit the scope or substance of the invention.

Further, the term “or” as used in this disclosure and the appended claims is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form. Throughout the specification and claims, the following terms take at least the meanings explicitly associated herein, unless the context dictates otherwise. The meanings identified below do not necessarily limit the terms, but merely provide illustrative examples for the terms. The meaning of “a,” “an,” and “the” may include plural references, and the meaning of “in” may include “in,” “at,” and/or “on,” unless the context clearly indicates otherwise. The phrase “in one embodiment,” as used herein does not necessarily refer to the same embodiment, although it may.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within the ranges as if each numerical value and sub-range is explicitly recited. As an illustration, a numerical range of “about 1 to 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc. as well as 1, 2, 3, 4, and 5, individually. The same principle applies to ranges reciting only one numerical value as a minimum or a maximum. Furthermore, such an interpretation should apply regardless of the breadth of the range or the characteristics being described.

The present invention is a composition and a method of using the composition to reduce odor on a textile material. The composition reduces odor without the use of heavy metals. The term “heavy metal”, as used herein, refers to any metal heavier than magnesium (atomic weight of 243 grams/mole).

Sodium pyrithione is a particle-free, heavy metal-free, water-soluble compound. Sodium pyrithione is a moderately alkaline chemical in nature such that it can be utilized to neutralize acidic odorants, such as isovaleric acid and acetic acid, which are common body odorants.

In an aspect of the invention, a composition is provided comprising sodium pyrithione and a binder. The composition is heavy metal-free (meaning without heavy metal).

The hinder is a polymeric binder, and is preferably selected from the group consisting of a polyacrylic binder, a polyurethane binder, and a combination thereof. The binder binds the sodium pyrithione to the textile allowing the sodium pyrithione to impart prolonged odor control to the textile.

The composition may comprise sodium pyrithione and binder in a ratio from 1:1 to 1:5, 1:2 to 1:3, 1:2 to 1:5, 1:3 to 1:5. 1:1 to 1:4, 1:1 to 1:3, 1:1.5 to 1:3, or 1:25 to 1:35.

The odor control composition may comprise from 6 weight percent to 15 weight percent sodium pyrithione. Preferably, the odor control composition comprises from 8 weight percent to 13 weight percent sodium pyrithione. More preferably, the odor control composition comprises from 10 weight percent to 12 weight percent sodium pyrithione.

The odor control composition may comprise from 40 weight percent to 55 weight percent of the binder. Preferably, the odor control composition comprises from 43 weight percent to 50 weight percent of the binder. More preferably, the odor control composition comprises from 45 weight percent to 48 weight percent of the binder.

In some embodiments, the binder is a combination of polyacrylic binder and polyurethane binder. The odor control composition may comprise from 25 weight percent to 35 weight percent of the polyacrylic binder. Preferably, the odor control composition comprises from 27 weight percent to 33 weight percent of the polyacrylic binder. More preferably, the odor control composition comprises from 29 weight percent to 31 weight percent of the polyacrylic binder. The odor control composition may comprise from 15 weight percent to 20 weight percent of the polyurethane binder. Preferably, the odor control composition comprises from 16 weight percent to 19 weight percent of the polyurethane binder. More preferably, the odor control composition comprises from 17 weight percent to 18 weight percent of the polyurethane binder.

The combination of two binders may be used to stabilize the dispersion. Additionally, the two binders may have varying affinities towards the active component, sodium pyrithione and the textile material, polyester. The ratio of binders may be tailored to have work as a crosslinker between the textile material and the sodium pyrithione.

In an aspect of the invention, a composition is provided comprising sodium pyrithione, a binder, and an optional softener. The softener may be selected from the group consisting of a sulphated fatty alcohol, anionic fatty acid polysiloxane, nonionic fatty acid polysiloxane, ethoxylated polysiloxane, polyethylene based softener, and a combination thereof. The odor control composition may comprise from 15 weight percent to 20 weight percent of the softener. Preferably, the odor control composition comprises from 16 weight percent to 19 weight percent of the softener. More preferably, the odor control composition comprises from 17 weight percent to 18 weight percent of the softener.

In one aspect, the composition comprises: 10 weight percent to 15 weight percent of sodium pyrithione; 25 weight percent to 30 weight percent of binder; 15 weight percent to 30 weight percent of softener; and a balance of water; wherein the weight percentages are based on the weight of the total composition.

In another aspect, the composition comprises 10 weight percent to 15 weight percent of sodium pyrithione, 40 weight percent to 55 weight percent of binder, 15 weight percent to 30 weight percent of softener, and a balance of water; wherein the weight percentages are based on the weight of the total composition.

In another aspect, the composition comprises 6 weight percent to 15 weight percent of sodium pyrithione, 25 weight percent to 35 weight percent of polyacrylic binder, 15 weight percent to 20 weight percent of polyurethane binder, 15 weight percent to 20 weight percent of softener, and a balance of water.

The composition can be applied by a pad and cure method, wherein the curing temperature is in a range of 130° C. to 180° C. for a minimum 45 seconds. This composition can also be used by an exhaustion method, wherein the chemicals can be added during the dyeing stage at a temperature range of 60° C. to 130° C. for 20 minutes to one hour.

The composition of the present invention has surprising odor control effects. Additionally, the composition has improved color-fastness and tactile sensation compared to compositions with heavy metals.

In an aspect of the invention, a method of using a composition comprising sodium pyrithione for odor control. The composition may further comprise a binder and a softener.

The composition can be used on disposable or single-use odor control applications, but also on a reusable textile product including, but not limited to, yarn, filament, fabric, clothing, apparel, footwear, bedding, curtain, uniform, carpet, upholstery, face mask, gown, upholstery, foam, non-woven filter, among others.

### WORKING EXAMPLES

### Example 1—Compositions

For the following examples, a pre-mix composition was prepared prior to application to the textile. Composition 1 includes: 11 weight percent sodium pyrithione, 30 weight percent polyacrylic binder, 17 weight percent polysiloxane softener, and a balance of water. Composition 2 includes: 11 weight percent sodium pyrithione, 30 weight percent polyacrylic binder, 17 weight percent polyurethane binder, 17 weight percent polysiloxane softener, and a balance of water. The premix is applied to the textile at the listed amounts on weight of fabric (o.w.f).

### Example 2—Odor Capture Performance

Odor capture performance was tested following ISO 17299-3 test method using isovaleric acid as the odorant. For disposable and single-use applications, both sodium pyrithione alone or sodium pyrithione with binder and softener provide significant odor reduction by absorbing more than 85% of the dosed odorant. Results are presented in Table 1.

TABLE 1
ISO 17299-3 odor capture result on single use applications

| | ISO 17299-3 IVA, |
|---|---|
| Sample Description | Odor Capture |
| 1.5% o.w.f. sodium pyrithione on polyester | 87% |
| fabric. No laundry needed. | |
| 2.2% percent o.w.f. sodium pyrithione | 90% |
| o.w.f. polyacrylic binder + polysiloxane | |
| softener on polyester fabric. No laundry | |
| needed* | |
| 2.5% o.w.f sodium pyrithione, polyacrylic | 95% |
| binder, polyurethane binder, and | |
| polysiloxane softener on polyester fabric. | |
| No laundry needed** | |

*Treated with Composition 1.
**Treated with Composition 2.

For reusable textiles that require extended cycles of launderings, certain types of polymer-binders are formulated with sodium pyrithione to prevent the water-soluble sodium pyrithione being washed off, therefore imparting wash durability to the textiles. When each ingredient was treated on polyester fabrics alone, it had minimal odor absorption after extended cycles of home launderings. When sodium pyrithione was applied in combination with polyacrylic binder and a polysiloxane softener, a durable polymer coating was formed on the polyester substrates, therefore it had sustained efficacy. When sodium pyrithione is applied with both polyacrylic binder and polyurethane binder, along with the softener, the odor control maintained sustained efficacy. Results are shown in Table 2.

TABLE 2
ISO 17299-3 Odor Capture On Reusable Applications

| | ISO 17299-3 IVA, |
|---|---|
| | Odor Capture |
| Sample Description | 25 Home Launderings (HL) |
| 1.5% o.w.f. sodium pyrithione on polyester | 5% |
| fabric, 25HL | |
| 1% o.w.f. polyacrylic binder on polyester | 4% |
| fabric, 25HL | |
| 1% o.w.f. polysiloxane softener on | 5% |
| polyester fabric, 25HL | |
| 1.5% o.w.f. sodium pyrithione + 1% o.w.f. | 71% |
| polyacrylic binder on polyester fabric, 0HL | |
| 2.2% o.w.f. sodium pyrithione o.w.f. | 67% |
| polyacrylic binder, and polysiloxane | |
| softener on polyester fabric, 25HL* | |
| 2.5% o.w.f sodium pyrithione, polyacrylic | 76% |
| binder, polyurethane binder, and | |
| polysiloxane softener on polyester fabric, | |
| 25HL** | |

*Treated with Composition 1.
**Treated with Composition 2.

### Example 3—Colorfastness Benefit to a Textile

This particle-free sodium pyrithione composition neither causes any machinery build-up issues nor does it leave a poor tactile sensation on textiles. Color fastness to crocking and to laundering were measured following AATCC TM 8 and AATCC TM61-2A, respectively. Color fastness scores read from 1 to 5. The higher the grade, the better the color fastness. This formula was found to have minimal impact to color features. Results are listed in Tables 3 and 4.

TABLE 3
Color fastness to crocking

| Fabric | Dry | Wet |
|---|---|---|
| 2.2% o.w.f. sodium pyrithione o.w.f. | 5 | 4.5 |
| polyacrylic binder + polysiloxane | | |
| softener on polyester fabric* | | |
| 2.5% o.w.f sodium pyrithione, | 4.5 | 4.5 |
| polyacrylic binder, polyurethane binder, | | |
| and polysiloxane softener on polyester | | |
| fabric.** | | |
| Untreated black polyester | 4.5 | 4.5 |

*Treated with Composition 1.
**Treated with Composition 2.

TABLE 4
Color fastness to laundering

| Fabric | Wool | Acrylic | Polyester | Nylon | Cotton | Acetate |
|---|---|---|---|---|---|---|
| 2.2% o.w.f. sodium pyrithione o.w.f. | 4.5 | 5 | 4.5 | 3.5 | 4.5 | 3 |
| polyacrylic binder + polysiloxane | | | | | | |
| softener on polyester fabric* | | | | | | |
| Untreated black polyester | 4. | 4.5 | 3.5 | 4 | 4.5 | 3.5 |

It will therefore be readily understood by those persons skilled in the art that the present invention is susceptible of broad utility and application. Many embodiments and adaptations of the present invention other than those herein described, as well as many variations, modifications and equivalent arrangements, will be apparent from or reasonably suggested by the present invention and the foregoing description thereof, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements.

What is claimed is:

1. An odor control composition comprising:
sodium pyrithione at an effective amount to reduce odor on a textile, and
a binder at an effective amount to coat the textile.

2. The odor control composition according to claim 1, wherein the sodium pyrithione is present from 6 weight percent to 15 weight percent.

3. The odor control composition according to claim 1, wherein the binder is present from 40 weight percent to 55 weight percent.

4. The composition according to claim 1, wherein the composition is heavy metal-free.

5. The odor control composition according to claim 1, wherein the binder is selected from the group consisting of a polyacrylic binder, a polyurethane binder, and a combination thereof.

6. The odor control composition according to claim 1, further comprising from 15 weight percent to 20 weight percent of a softener.

7. The odor control composition according to claim 1, wherein water is the balance of the total weight of the composition.

8. The odor control composition according to claim 1, Wherein the odor control composition, when applied to a textile, reduces odors up to twenty-five home launderings.

9. An odor control composition comprising:
sodium pyrithione at an effective amount to reduce odor on a textile,
a binder at an effective amount to coat the textile, and
from 15 weight percent to 20 weight percent of a softener.

10. The odor control composition according to claim 9, wherein sodium pyrithione is present from 6 weight percent to 15 weight percent.

11. The odor control composition according to claim 9, wherein the binder is present from 40 weight percent to 55 weight percent.

12. The odor control composition according to claim 9, wherein the composition is heavy metal-free.

13. The odor control composition according to claim 9, wherein the binder is selected from the group consisting of a polyacrylic hinder, a polyurethane binder, and a combination thereof.

14. The odor control composition according to claim 9, wherein the softener is selected from the group consisting of a sulphated fatty alcohol, anionic fatty acid polysiloxane, nonionic fatty acid polysiloxane, ethoxylated polysiloxane, polyethylene based softener, and a combination thereof.

15. The odor control composition according to claim 9, wherein water is the balance of the total weight of the composition.

16. The odor control composition according to claim 9, wherein the odor control composition, when applied to a textile, reduces odors up to twenty-five home launderings.

17. An odor control composition comprising:
sodium pyrithione at an effective amount to reduce odor on a textile,
from 25 weight percent to 35 weight percent of polyacrylic binder, and
from 15 weight percent to 20 weight percent of polyurethane binder.

18. The odor control composition according to claim 17, wherein the sodium pyrithione is present from 6 weight percent to 15 weight percent.

19. The odor control composition according to claim 17, further comprising from 15 weight percent to 20 weight percent of a softener.

20. The odor control composition according to claim 19, wherein the softener is selected from the group consisting of a sulphated fatty alcohol, anionic fatty acid polysiloxane, nonionic fatty acid polysiloxane, ethoxylated polysiloxane, polyethylene based softener, and a combination thereof.

21. The odor control composition according to claim 17, wherein the composition is heavy metal-free.

22. The odor control composition according to claim 17, wherein water is the balance of the total weight of the composition.

23. The odor control composition according to claim 17, wherein the odor control composition, when applied to a textile, reduces odors up to twenty-five home launderings.

24. A method of treating a textile, the method comprising:
applying a composition to a textile, the composition comprising:
sodium pyrithione at an effective amount to reduce odor on the textile, and
a binder at an effective amount to coat the textile
thereby imparting a property of odor control to the textile.

25. The method according to claim 24, wherein the sodium pyrithione is present in the composition from 6 weight percent to 15 weight percent.

26. The method according to claim 24, wherein the binder is present in the composition from 40 weight percent to 55 weight percent.

27. The method according to claim 24, wherein the composition is heavy metal-free.

28. The method according to claim 24, wherein the composition further imparts wash durability up to twenty-five home launderings.

29. The method according to claim 24, wherein the binder is selected from the group consisting of a polyacrylic binder, a polyurethane binder, and a combination thereof.

30. The method according to claim 24, wherein the composition further comprises from 15 weight percent to 20 weight percent of a softener.

31. The method according to claim 24, wherein water is the balance of the composition.

32. The method according to claim 24, wherein the textile is a fabric.

33. The method according to claim 24, wherein the softener is selected from the group consisting of a sulphated fatty alcohol, anionic fatty acid polysiloxane, nonionic fatty acid polysiloxane, ethoxylated polysiloxane, polyethylene based softener, and a combination thereof.

34. The method according to claim 24, wherein the composition is applied by a method selected from the group consisting of padding, spraying, roller coating, exhaustion, and a combination thereof.

35. The method according to claim 24, wherein the composition is applied to the textile by padding in a padding bath.

36. The method according to claim 35, wherein the textile after padding is cured at a curing temperature in a range of 130° C. to 180° C.

37. The method according to claim 35, wherein the textile after padding is cured for a minimum of 45 seconds.

38. The method according to claim 24, wherein the composition is applied to the textile by exhaustion.

39. The method according to claim 38, wherein the composition is added during a dyeing stage of exhaustion.

40. The method according to claim 24, wherein the composition is added at a temperature in a range of 60° C. to 130° C.

41. The method according to claim 36, wherein the composition is exhausted for a time period from twenty minutes to one hour.

42. The method according to claim 24, wherein a color of the textile remains visually unchanged after applying the composition.

43. An article, the article comprising a textile material, wherein the textile material is treated with a composition comprising:
sodium pyrithione at an effective amount to reduce odor on the textile, and
a binder at an effective amount to coat the textile.

44. The article according to claim 43, wherein the sodium pyrithione is present from 6 weight percent to 15 weight percent.

45. The article according to claim 43, wherein the binder is present from 40 weight percent to 55 weight percent.

46. The article according to claim 43, wherein the article is heavy metal-free.

47. The article according to claim 43, wherein the binder is selected from the group consisting of a polyacrylic binder, a polyurethane binder, and a combination thereof.

48. The article according to claim 43, wherein the composition further comprises from 15 weight percent to 20 weight percent of a softener.

49. The article according to claim 43, wherein water is the balance of the total weight of the composition.

50. The article according to claim 43, wherein the odor control composition, when applied to a textile, reduces odors up to twenty-five home launderings.
